(19) United States
(12) Patent Application Publication
(10) Pub. No.: US 2014/0048983 A1
(43) Pub. Date: Feb. 20, 2014

(54) METHOD AND DEVICE FOR PRODUCING SYNTHETIC GRASS FIBERS

(71) Applicants: Jens Weinhold, Chemnitz (DE); Steffen Husfeldt, Niederfrohna (DE)

(72) Inventors: Jens Weinhold, Chemnitz (DE); Steffen Husfeldt, Niederfrohna (DE)

(73) Assignee: OERLIKON TEXTILE GmbH & Co. KG, Remscheid (DE)

(21) Appl. No.: 14/113,715

(22) PCT Filed: Jun. 1, 2012
(86) PCT No.: PCT/EP2012/060337

§ 371 Date: Oct. 24, 2013

(30) Foreign Application Priority Data
Jun. 3, 2011 (DE) 10 2011 103 296.0

(51) Int. Cl. B29D 99/00

(52) U.S. Cl. CPC B29D 99/0078
USPC 264/469; 425/76

(57) ABSTRACT

The invention relates to a method and to a device for producing synthetic grass fibers for artificial turf. For said purpose, a plurality of strips formed from a divided film or a plurality of individually extruded monofilaments made of a polymer material are produced in an extrusion process. The strips or monofilaments are then stretched and wound individually or as a fiber bundle to form coils. According to the invention, in order to in particular influence the physical properties of the synthetic grass fibers in addition to the visual properties, the roughness of the surfaces of the strips or monofilaments is changed before or after the winding. For said purpose, the device according to the invention has a treatment apparatus, the means of which are suitable for changing the surface roughness of the strips or monofilaments.

### CROSS REFERENCE TO RELATED APPLICATIONS

This application is a national stage application, filed under 35 U.S.C. § 371, of International Application No. PCT/EP2012/060337, filed Jun. 1, 2012, which claims priority to and the benefit of German Application No. 10 2011 103 296.0, filed Jun. 3, 2011, the contents of both of which are hereby incorporated by reference in their entirety.

### BACKGROUND

1. Technical Field

The invention relates to a method for the production of synthetic grass yarns for artificial turf, as well as to a device for the production of synthetic grass yarns.

2. Description of Related Art

A method in the class and a device in the class are known from DE 10 2009 037 740 A1, by way of example.

The production of the synthetic grass yarns takes place in a single-stage extrusion process, wherein the yarns are formed from a plurality of individual strips which are cut from an extruded film, or from a plurality of monofilaments which are extruded by a spinning head. Following the extrusion, the strips or the monofilaments are typically drawn and rolled on spools either individually or in groups. In order to cultivate the physical properties of the yarns in addition to the visual characteristics thereof, wherein the latter are typically determined by a green coloring of the yarns, additional processing steps are preferably carried out prior to the spooling of the grass yarns. During the process, the attempt is made to obtain properties which mimic those of typical natural grasses. In the known method and with the known device, a fibrillation is carried out on the grass yarns for this purpose, in order to produce a fibrous structure. The overall structure of the yarn in this case can also be modified by a crimping.

In addition to the visual appearance of the grass yarns, which particularly determines the appearance of an artificial turf formed using the grass yarns, an attempt is also made to establish typical properties of natural grass yarns, such as friction behavior or wetting behavior by water, by way of example.

As such, a method is known from EP 0 259 940 B1 to produce a grass yarn with the least possible friction coefficient on the surfaces. For this purpose, additional materials are mixed together with a polymer prior to the extrusion of the same, such that overall the properties of the polymer are modified. Such methods therefore have the disadvantage that the properties of the starting material are modified overall due to the addition of an additional material.

In contrast, a method for the production of a grass yarn is known from WO 99/40246 A1, wherein a surface coating is partially applied to a yarn such that different zones are formed on the yarn with and without coatings. However, this approach only allows the production of uneven surface properties on the yarn, which then influence, by way of example, the wetting behavior of the yarn unevenly according to the surface characteristics. In addition, partial coatings are created on the surface of the yarn in patterns which cannot be reproduced, such that each of the yarns in the artificial turf has a surface property which depends on the pattern of the partial coating.

### BRIEF SUMMARY

The problem addressed by the invention is therefore that of further improving the method in the class for the production of synthetic grass yarns, and the device in the class for the production of synthetic grass yarns, in such a manner that the grass yarns have an even, predetermined surface structure in addition to the properties determined by the polymer material.

A further goal of the invention is that of improving the known method and the known device for the production of synthetic grass yarns in such a manner that that it is possible to produce, in addition to the visual properties of natural grasses, also the typical physical properties of natural grasses, in a reproducible manner.

A further problem addressed by the invention is that of providing a method and device for the production of synthetic grass yarns which have hydrophilic surfaces for improved retention of water.

The problem addressed by the invention, as concerns the method, is solved in that the surface roughness of the strips or the monofilaments is modified prior to, or following, the spooling thereof.

The device according to the invention solves the problem by including a treatment device which has means for the modification of the surface roughness of the strips or the monofilaments.

Advantageous implementations of the invention are defined by the features and the combinations of features in the dependent claims.

The invention possesses the particular advantage that it is possible to modify nothing other than the surfaces of the strips or mono filaments, said surfaces being created following the extrusion and cooling, while not altering the visual properties of the strips or monofilaments. As such, it has been determined that the surface roughness of the strips or the monofilaments significantly influences the behavior of an artificial turf when the same is wetted, and the behavior of an artificial turf when sports equipment, such as a football, by way of example, slides thereon, or when a fallen player slides thereon. As such, the surface roughness of synthetic grass yarns is subject to special requirements which generally are not achieved by the extrusion of synthetic yarns by means of the conventional extrusion tools. For this reason, the invention is particularly advantageous for the purpose of making it possible to generate a surface roughness on the strips or monofilaments which is matched to the special application thereof.

The roughness of the surfaces of the strips or monofilaments can be generated in principle in a manner involving contact, or no contact. In this case, it has proven particularly suitable to use a method variant wherein the roughness of the surfaces of the strips or monofilaments is modified by a coating and/or a material conversion. In the case of a coating, additional material components can be used, including nanoparticles, by way of example, to obtain a predetermined structure for the roughness on the surface. The modification of the roughness in this case can fundamentally lead to higher or lower roughness values on average.

In a material conversion, the molecular structure of the starting polymer is preferably incorporated to obtain a surface modification of the roughness.

In order to make it possible to execute a coating or a material conversion for strips and monofilaments which are continuous, and also at elevated speeds of more than 100 m/min., the method variant is preferably used in which the coating and/or the material conversion is generated on the surface of the strips or monofilaments by a plasma treatment.

The plasma treatment of the surfaces of the strips in this case is advantageously carried out after the drawing and prior to the spooling of the strips, such that the strips or monofilaments produced in this manner have a surface structure which is ready for the further processing into an artificial turf.

Because natural grasses commonly have a different upper side and lower side, the implementation of the invention is particularly advantageous wherein the surfaces of a lower side of the strips or monofilaments and the surfaces of an upper side of the strips or monofilaments are treated one after the other in two steps. As such, it is possible to produce the lower side of the strips and the upper side of the strips with different or identical surface roughness.

For the production of synthetic grass yarns, strips or monofilaments of the polymer material polyethylene, or the ULDPE, MLDPE, LLDPE or HDPE variants thereof, have proven particularly suitable. However, it is also possible to advantageously produce strips from other polymer materials, such as polypropylene, polyester, or polyamide, by way of example, using the method according to the invention.

The device according to the invention is particularly characterized in that the surfaces which are desired for the grass yarns can be produced individually on the strips or monofilaments generated for the yarns. For this purpose, a treatment device is included which has means for the modification of the surface roughness of the strips or monofilaments. By way of example, it is possible in this manner to convert the surfaces which have a hydrophobic functionality, after the extrusion and drawing of the strips, into a hydrophilic surface. Such hydrophilic surfaces of the grass yarns are particularly advantageous for obtaining a continuous wetting when artificial turfs are watered. In addition, the ability of the grass yarns to have a continuous wetting is advantageous in preventing overheating of the yarns during extreme sliding friction events, such as when a player falls, by way of example. As such, it is possible to advantageously prevent burns upon skin contact with a player. In addition, it is thereby possible to advantageously prevent and/or reduce a heating of the artificial turf.

The device according to the invention is preferably used for the online production of such grass yarns, such that the treatment device is arranged between the drawing device and the spooling device.

In order to make it possible to maintain typical process speeds for extrusion, the implementation of the device according to the invention, wherein the means of the treatment device have at least one high-voltage electrode and a gas mixture, has proven particularly suitable, wherein it is possible to carry out a plasma treatment for the surface of the strips or monofilaments using said high-voltage electrode and gas mixtures.

In this case, the treatment of the extruded strips or monofilaments is preferably carried out on the upper side and the lower side separately, such that the implementation of the device according to the invention which has the treatment device with at least two stations is preferably used, wherein it is possible to separately treat a lower side of the strips or monofilaments and an upper side of the strips or monofilaments. The treatment stations of the treatment devices can be constructed with identical means for the surface roughness modification, or with different means for modifying the surface roughness. As a result, it is possible to produce surface characteristics on the upper and lower sides separately, wherein these characteristics mimic typical natural grasses.

### DETAILED DESCRIPTION OF THE DRAWINGS

The method according to the invention is described below in greater detail in the context of several embodiments of the device according to the invention, with reference to the attached figures, wherein:

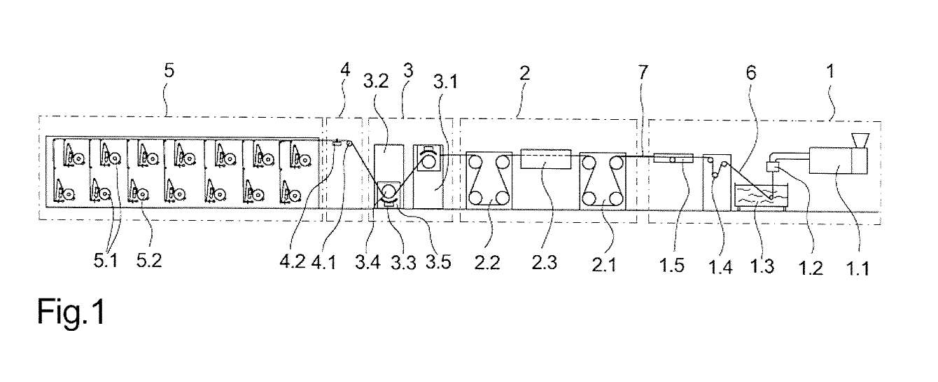

FIG. 1 shows a schematic side view of one embodiment of the device according to the invention, and

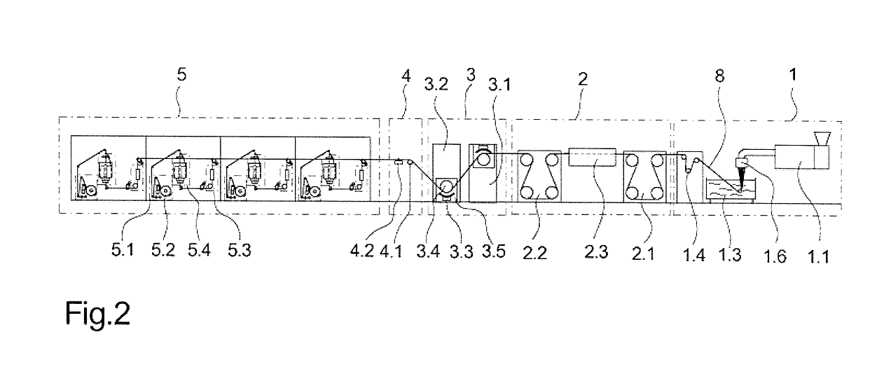

FIG. 2 shows a schematic side view of another embodiment of the device according to the invention.

### DETAILED DESCRIPTION OF VARIOUS EMBODIMENTS

A first embodiment of the device according to the invention is shown in FIG. 1 in a full, schematic view. The embodiment has an extrusion device 1, a drawing device 2, a treatment device 3, a separating device 4, and a winding device 5, which are arranged one behind the other in the direction of the yarn and which produce a plurality of grass yarns in a single-stage process.

The extrusion device 1 is formed in this embodiment by an extruder 1.1 and an extruder head 1.2 which is connected to the extruder 1.1. A cooling bath 1.3 is included below the extruder head 1.2 and is filled with a cooling liquid. A deflecting device 1.4 and a cutting device 1.5 are connected to the output of the cooling bath 1.3.

A starting polymer, for example a polyethylene, is melted inside the extrusion device 1, and is fed to the extrusion head 1.2 under pressure. A flat film 6 is extruded at the extrusion head 1.2 and cooled in the cooling bath 1.3.

The drawing of the film 6 is carried out by the drawing device 2 which has a first godet unit 2.1 and a second godet unit 2.2. As such, the drawing forces are generated via the first godet unit 2.1 to draw the film 6.

Before the film 6 is fed to the drawing device 2, the film 6 is dried via the deflecting device 1.4 and the film 6 is cut via the cutting device 1.5 into a plurality of individual strips 7. As such, the strips 7 are fed to the drawing device 2 as a common web of strips. A heating device 2.3 is arranged between the first godet unit 2.1 and the second godet unit 2.2, and a thermal treatment of the strips 7 is carried out by said heating device 2.3. The godets of the second godet unit 2.2 are driven at a higher circumferential speed than the godets of the first godet unit 2.1, such that the strips 7 are drawn.

The drawing device 2 illustrated in FIG. 1 is illustrated as an example having only two godet units 2.1 and 2.2. In principle, such drawing devices 2 can have multiple stretching zones, wherein a shrinking zone could also be assigned to the stretching zones, wherein it would be possible to carry out a shrink treatment to release tensions in the strips 7.

A treatment device 3 is arranged between the drawing device 2 and the winding device 5. The treatment device 3 has a first treatment station 3.1 and a second treatment station 3.2. Both of the treatment stations 3.1 and 3.2 contain means for the modification of the surface roughness of the strips 7. In this case, an upper side of the strips 7 is treated in the treatment station 3.1, and a lower side of the strips 7 is treated in the treatment station 3.2. The treatment stations 3.1 and 3.2 have an identical design, and have a plasma chamber 3.5, as means for the modification of the surface roughness of the strips, wherein a guide roll 3.4 and a high-voltage electrode 3.3 are arranged in said plasma chamber 3.5. As such, it is possible to carry out a plasma treatment on the surfaces of the strips. For this purpose, a gas mix, which is set to a working pressure and a working temperature, is fed to the plasma chamber 3.5. An energy is generated by the high-voltage electrode to initiate the desired reaction in the gas mix and on the surface of the strips. In particular, in this case the principle of atmospheric pressure plasma discharge in a controlled gas atmosphere has proven suitable.

In order to wind the strips 7 into spools inside the winding device 5, a separating device 4 is included between the treatment device 3 and the winding device 5, by means of which the strips 7 are separated or [sic] are fed to multiple spooling stations 5.1 of a plurality of spooling stations 5.1 of the winding device 5. The separating device 4 has a deflecting roll 4.1 and a guide rail 4.2 for this purpose.

The spooling stations 5.1 are arranged in two levels one above the other inside the winding device 5, wherein one of the strips 7 or a group of strips 7 is wound in each spooling station 5.1 into a spool 5.2.

The embodiment of the device according to the invention in the embodiment illustrated in FIG. 1 is therefore particularly suitable for producing [sic] the method according to the invention for the production of synthetic grass yarns for artificial turf in a single-stage process. A polyethylene of the type ULDPE, MLDPE, LLDPE, or HDDPE is preferably used in this case as the polymer material. The separate treatment of the lower sides and the upper sides of the strips thereby enables an individual treatment and production of the surface roughnesses of the strips, in order to produce the surface properties of the natural grasses as a result of special roughnesses.

A further embodiment of the device according to the invention for the production of synthetic grass yarns is illustrated schematically in FIG. 2. The construction and the function of the embodiment is substantially identical to the embodiment according to FIG. 1, such that only the differences are explained here to avoid repetition, wherein reference is hereby made to the foregoing description for the remaining configuration.

In the embodiment illustrated in FIG. 2, an extrusion device 1, a drawing device 2, a treatment device 3, a separating device 4, and a winding device are arranged one behind the other in the direction of the yarn. The drawing device 2, the treatment device 3, and the separating device 4 have an identical design to the embodiment according to FIG. 1 as above, such that reference is hereby made to the foregoing description.

In the extrusion device 1, the extruder 1.1 is connected to a spinning head 1.6. A cooling bath 1.3 is functionally assigned to the spinning head 1.6 on the lower side thereof. The spinning head 1.6 has a plurality of nozzle openings on its lower side, through which one monofilament 8 each is extruded. As such, a plurality of monofilaments 8 is extruded via the spinning head 1.6 from the polymer melt generated by the extruder 1.1, and is fed to the cooling bath 1.3. The monofilaments 8 are drawn by the drawing device 2, via the deflecting device 1.4, as a web of strips. The monofilaments 8 are dried on the deflecting device 1.4. The deflecting device 1.4 has at least one suction means for this purpose, which is not illustrated in detail here, for the purpose of removing the residual liquid.

After the drawing and two-side treatment of the monofilaments 8, a separation of the monofilaments 8 into multiple groups is carried out via the separating device 4, wherein each group has 4 to 8 monofilaments. The fiber composite of the monofilaments is fed to a further treatment in multiple stations inside the winding device 5. As such, the winding device 5 has multiple treatment modules arranged one behind the other on a wall stand, each of which has a crimping station 5.3, a winding station 5.4, and a spooling station 5.1. The fiber bundle of the monofilaments 8 runs through the crimping station 5.3, the winding station 5.4, and the spooling station 5.1, wherein the monofilaments 8 obtain a crimp in the crimping station 5.3, and then are wound with a binding thread in the winding station 5.4. The resulting fiber bundle of the monofilaments 8 is subsequently wound by the spooling station 5.1 into a spool 5.2.

Such a winding device is known from WO 2010/102921 A1, such that reference is hereby made at this point to the document, and no further descriptions shall be given.

In the embodiment illustrated in FIG. 2, the monofilaments 8 are extruded by the spinning head 1.6, each with a linear cross-section, such that a separate treatment of the upper side and the lower side of the monofilaments 8 is likewise possible following the drawing, by the treatment station 3.1 and 3.2. However, the possibility also exists in principle of the monofilaments having an elliptical or circular cross-section which can be treated in a treatment station. As such, the treatment device 3 illustrated in FIG. 2 could also be formed by only one of the treatment stations.

The method according to the invention and the device according to the invention have proven particularly suitable for refining the physical properties of the synthetic grass yarns produced in this way, in such a manner that the surface properties result which are typical for natural grasses. In particular, it has been possible to significantly improve the capacity for wetting following the surface treatment of the strips or monofilaments. In the case of conventional extruded polymer surfaces, when wetted with water, a formation of droplets occurs and leads to a rapid dropping-off and run-off of the water. By modifying the surface roughness, it has been possible to achieve a configuration wherein the applied water is distributed evenly over the entire surface, and forms a film which adheres significantly longer to the surface of the grass yarns. As such, the synthetic grass yarns produced in this manner are advantageously suitable for artificial turf which is used for athletic applications.
LIST OF REFERENCE NUMBERS
1 extrusion device
1.1 extruder
1.2 extrusion head
1.3 cooling bath
1.4 deflecting device
1.5 cutting device
1.6 spinning head
2 drawing device
2.1 first godet unit
2.2 second godet unit
2.3 heating device
3 treatment device
3.1 first treatment station
3.2 second treatment station
3.3 high-voltage electrode
3.4 guide roll
3.5 plasma chamber
4 separating device
4.1 deflecting roll
4.2 guide rail
5 spooling device
5.1 spooling station
5.2 spool
5.3 crimping station
5.4 winding station
6 film
7 strips
8 mono filaments

1-10. (canceled)

11. A method for the production of synthetic grass yarns for artificial turf, wherein:
at least one of a plurality of strips formed from a divided film or a plurality of individually extruded monofilaments is generated from a polymer material in an extrusion process;
the strips or the monofilaments are drawn;
the strips or monofilaments are wound individually or as a fiber bundle into spools; and
the roughness of the surfaces of the strips or monofilaments is modified prior to or following the winding.

12. A method according to claim 11, wherein the roughness of the surfaces of the strips or monofilaments is modified by a coating and/or a material conversion.

13. A method according to claim 12, wherein the coating and/or the material conversion on the surfaces of the strips or monofilaments is generated by a plasma treatment.

14. A method according to claim 13, wherein the plasma treatment of the surfaces of the strips or monofilaments is carried out after the drawing of the strips or mono filaments.

15. A method according to claim 14, wherein the plasma treatment of the surfaces of the strips or monofilaments is carried out prior to the winding of the strips or mono filaments.

16. A method according to claim 11, wherein the surfaces on a lower side of the strips or monofilaments and the surfaces on an upper side of the strips or monofilaments are treated one after the other in two steps.

17. A method according to claim 11, wherein the strips or monofilaments are produced from polyethylene.

18. A method according to claim 17, wherein the strips or monofilaments are selected from a group consisting of ULDPE, MLDPE, LLDPE, and HDPE.

19. A device for the production of synthetic grass yarns for artificial turf, said device comprising:
an extrusion device (1) configured for generating at least one of synthetic strips (7) or monofilaments (8);
a drawing device (2) configured for drawing the strips (7) or monofilaments (8);
a winding device (5) configured for winding the strips (7) or monofilaments (8) into a plurality of spools; and
a treatment device (3) comprising means (3.3, 3.4, 3.5) for the modification of the surface roughness of the strips (7) or monofilaments (8).

20. A device according to claim 19, wherein the treatment device (3) is arranged between the drawing device (2) and the winding device (5).

21. A device according to claim 19, wherein the means of the treatment device (3) comprises at least one high-voltage electrode (3.3) and a gas mix, by means of which it is possible to carry out a plasma treatment on the surfaces of the strips (7) or monofilaments (8).

22. A device according to claim 19, wherein the treatment device (3) further comprises at least two stations (3.1, 3.2) by means of which it is possible to separately treat a lower side of the strips (7) or monofilaments (8) and an upper side of the strips (7) or monofilaments (8).
